(19) United States
(12) Patent Application Publication
(10) Pub. No.: US 2008/0130879 A1
(43) Pub. Date: Jun. 5, 2008

(54) Method and system for a secure PKI (Public Key Infrastructure) key registration process on mobile environment

(75) Inventors: Petteri Heinonen, Espoo (FI); Michael Alexander Webster, Helsinki (FI); Juha Lindstrom, Espoo (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Valimo Wireless Oy

(21) Appl. No.: 11/977,423

(22) Filed: Oct. 23, 2007

(30) Foreign Application Priority Data
Oct. 23, 2006 (FI) 20060929

(51) Int. Cl. H04L 9/00

(52) U.S. Cl. 380/44; 380/277

(57) ABSTRACT

The invention relates to method and system for a secure PKI (Public Key Infrastructure) key registration process in a WPKI (Wireless PKI) environment comprising a registration server and client provided with a key pair. Especially the invention relates to a registration method, where a registration request for a public key of the key pair is formed using second and only part of the first information provided to a client in separated communication connections. The formed registration request comprising the public key is then provided with a verifying code determined over the request to the registration server in order to register the public key.

### CROSS-REFERENCE TO RELATED APPLICATIONS

This application claims priority under Section 119 to Finnish Patent Application No. 20060929 which was filed on Oct. 23, 2006.

### TECHNICAL FIELD OF THE INVENTION

The invention relates to method and system for a secure PKI (Public Key Infrastructure) key registration process on a mobile environment, and especially on a WPKI (Wireless PKI) environment comprising a registration server and a client, such as a terminal. Especially the invention relates to a registration method, where a registration request for a public key of a key pair generated in the terminal is provided to the registration server in order to be registered. Still the invention is applicable not only for keys generated on the terminal, SIM, UICC, or hardware module (tamper resistance), but also for pre-generated keys, such as keys stored during manufacturing or personalization of the terminal, SIM, UICC, and/or hardware module (client).

### BACKGROUND OF THE INVENTION

In order to being identified in a WPKI (Wireless PKI) environment a user should have a certain identification certificate including PKI public key (and corresponding private key stored securely) used for signing and opening messages sent by the user, for example. It is known from the prior art to provide a PKI key pair beforehand for example by a manufacturer of the terminal, or SIM/UICC-card (SIM stands for Subscriber Identity Module, and UICC for Universal Integrated Circuit Card) of the terminal, if the key pair of SIM/UICC-card is used, as well also to generate keys “on-board”. It is also known to use secured transmission path between the OTA server (Over The Air) and SIM-card when delivering a key pair to the SIM-card. When the manufacturer generates the key pair or just a key (private PKI key or a symmetric key), the public key of the key pair can be registered and connected to the user identification information reliably when the user is known when the key pair is stored in his/her terminal or the terminal with the key pair is given to the user, for example.

However, nowadays situations where a PKI key pair should be generated by a client, such as a terminal or by some component in the terminal (such as SIM/UICC-card) not until needed are become more general, such as also situations where pre-generated keys are not registered until need. To be reliable the public key of the generated key pair should be registered with a certification authority, such as a mobile operator, bank or government agency.

Prior art solutions have however some disadvantages namely when the new key pair is needed the user should bring his/her terminal to the trusted party, such as a certification authority, to generate the new key pair and register it trustworthy. This is a clear drawback. In addition, certain Man-In-The-Middle attacks are possible if transmission connection between the terminal and the certification authority, such as a registration server, is not secured, whereupon identity information or information relating to generated key pair can be stolen, and therefore the registration of the public key, for example, is not trustworthy. Securing the transmission connection is not always possible.

### SUMMARY OF THE INVENTION

An object of the invention is to provide a method and system for a secure PKI (Public Key Infrastructure) key registration process in a WPKI (Wireless PKI) environment comprising a registration server for registering keys and a client, such as a terminal requesting a registration of a key pair, and minimize the possibility to Man-In-The-Middle attacks, when the key information is delivered between the client and registration server, whether the key or key pair is generated by the client (on-board-generation) or is pre-generated (pre-generated for example by the manufacturer of the terminal, but not yet registered). Moreover an additional object of the invention is to minimize the data to be transmitted between the registration server and the client.

The object of the invention is fulfilled by providing a client requesting a registration of a key pair with a first and second part information, where said second part information and at least part of said first part information is used for a registration request with a public key to be registered, over which a verifying code, such as a hash code is determined, and after which the determined hash code and the public key to be registered is delivered to the registration server without said first and/or second information.

The present invention relates to a method and system. In addition the present invention relates to a registration server, terminal, and a computer program product.

In this document a client means a terminal, or, SIM, UICC, or hardware module (like trusted flash or embedded chip), which is tamper resistance and/or tamper proof, or other tamper resistance means typically used in the terminal. Moreover it should be noted that a key or key pair to be registered is generated by the client (“on-board”), but the key or key pair could also be pre-generated apart from the client, such as by the manufacturer of the client (terminal, SIM, UICC or hardware module) after which the client is provided with the pre-generated key and/or keys, and finally, when needed, a registration of the key (and/or keys) is requested by said client. The client may also be implemented by a circuit or computer program product comprising software code means typically run on the terminal, such as on a computer or a mobile phone.

In more details a public key of a key pair (including private and public keys) by which the client is provided must be registered at a registration server of a certification authority, for example. The registration server advantageously sends first information usable for forming a registration request to the client. First information may be random character string, proof of possession, user-specific information or combination of these, for example, and at least part of it is typically encrypted before sending. Encrypting is advantageously done using a public key of the client, where the public key used has been provided to the client beforehand for example by a manufacturer of the terminal, or SIM/UICC-card, or by an operator. Encryption is also typically done using asymmetric keys, and for example RSA-algorithm. Moreover first information is advantageously sent via a first data communication connection established between the registration server and terminal.

When said first information is received a possible encrypted part of it is decrypted by said client using its private key.

Furthermore the client is also provided by second information used for forming the registration request. Said second information may be environment data of the client, and/or information sent from the outside of the client, such as information sent via a second data communication connection separated from the first data communication connection used for transmitting said first information. Second information may be proof of possession or a challenge password, but may also be any other information, such as a random character string known also by the registration server. According to an embodiment of the invention said second information may be a combination of at least data or information described above, such as combination of environment data and information sent by the registration server. In addition said second information or at least part of it can contain a Luhn checksum or any other checksum and local validity check of the second information can be done.

After receiving said first and second information and generating a key pair, a registration request is formed combining said second part of information, at least part of said first information, and a public key of the generated (or pre-generated) key pair to be registered. Combination may be for example a string or table or some other form, where first and second information and the public key are provided in a certain order, such as successively, after which a verifying code is determined of the combination. The verifying code, which is advantageously a hash code of the combination, is advantageously determined using a one-way algorithm, such as a SHA-1 or SHA-2, MD5, RIPEMD, RIPEMD-160, (RIPEMD-128, RIPEMD-256, and RIPEMD-320), Tiger, or WHIRLPOOL algorithm. However, the registration server also knows the part of said first information used for combination, as well as said second information and the structure of the combination (string or table, for example) and a verifying code determination method.

When the verifying code is determined of the combination, the verifying code is advantageously signed using the private key of the key pair which public key to be registered is just delivered to the registration server. However the signing may also be optional, even though this (not signing) is very un-usual.

Next the (possibly) signed verifying code and public key are delivered to the registration server via a third communication connection, which is according to an embodiment of the invention the same as the first communication connection. However, it is to be noted that the third communication connection can also be separated from the first communication connection. In addition, according to an embodiment of the invention the third data communication connection is unsecured connection, whereas the first data communication connection is secured.

When the registration server receives the (possibly signed) verifying code and public key, it (encrypts said possibly signed verifying code and) combines a similar string or table or other combination of said first and second information and the public key received as the client did, and determines a verifying code over that combination using similar method as the client used, after which the registration server compares the verifying code determined by it itself to the verifying code received from the client and if these two verifying codes are identical, the registration server registers said public key received from the client.

According to a further embodiment of the invention a certain time window is triggered during which the verifying code and the public key to be registered must be received in the registration server in order to be registered. Otherwise the registration request is automatically refused in the registration server. The delivery of first information can be used for triggering the certain time window, for example.

By sending only the (possibly signed) verifying code and public key (forming a registration request) instead of sending also first and/or second information together with the public key a loading of a communication system used for data transmission between the client and registration server can be reduced. It should also be noted that when first (and possibly also second) information is encrypted before delivering to the client third parties couldn't determine the verifying code as determined by the client because they do not have first and/or second information with the public key, of which combination the verifying code is determined by the client.

For example if the third party wants to send his/her key to the registration server by stealing the verifying code and public key of the original user, and replacing the public key of the original user by his/her own public key, the registration server will recognize this because verifying codes wouldn't be identical, namely the verifying code determined by the registration server using first and second information delivered to the client with the public key of the third party would not be identical to the verifying code determined by the client. On the other hand if the third party determines a new verifying code using his/her public key, the registration server will still recognize this because the third party does not have first and second information used for determination of the verifying code in the client. This is an additional reason why first and second information are not delivered with the verifying code and/or public key to the registration server.

According to an embodiment of the invention also information gathered from the environment of the client can be used as second information or at least part of second information when determining a verifying code, such as client's serial number, information of an application or computer program product run on the terminal and/or information of SIM/UICC-card of the terminal and/or IMEI and/or IMSI and/or processor's ID number and/or terminal's uniquely identifying code and/or ICCID. A possibility is also to ask certain information from the user of the terminal. However, information above should also be known by the registration server in order to determine correct verifying code. Some information, which is not know to the registration server beforehand needs also to be transmitted from client to the registration server on the 3^{rd} communication or using some other means.

Said first information comprises advantageously a greater number of characters than said second information, which is typically only 8 bytes or characters, but not limited to 8 bytes or characters. Said second information may also comprise information about user name, address, ID-number, social security number or the like, and/or name of the user's company.

According to an embodiment of the invention a PIN-code can be asked from the user in order to activate decryption/encryption/signing, or generation of a new key pair. In an embodiment the PIN-code can also be taken into account when determining a verifying code.

In addition according to an embodiment of the invention the client is a SIM or UICC-card, a terminal, such as a mobile phone or portable computer comprising a SIM and/or UICC-card. Moreover it should be noted that even if this document states a client like a terminal used for generating and/or at least requesting a registration of a key pair and determining a verifying code, also a computer program product run on the terminal may perform these steps according to an embodiment of the invention. The computer program product is advantageously stored or at least performed at least partly on a SIM and/or UICC-card of the terminal. According to a further embodiment of the invention also SIM and/or UICC-card of the terminal can be at least partly used for generating and/or at least requesting a registration of a key pair and determining a verifying code over the combination of said first and second information and a key to be registered.

The present invention offers remarkable advantages over the known prior art solutions, because using the invention one can generate new PKI key pairs and register them at anytime needed, or request a registration of pre-generated key, without a great fear about the Man-In-The-Middle attacks. In addition the invention makes possible to reduce a loading of used communication systems, because only a verifying code and public key is needed to be delivered. Furthermore the invention is also powerful even if the third communication connection between a client and registration server is unsecured.

### BRIEF DESCRIPTION OF THE DRAWINGS

Next the invention will be described in greater detail with reference to exemplary embodiments in accordance with the accompanying drawings, in which

FIG. 1A illustrates a flow chart of an exemplary method for forming a registration request in a terminal according to an advantageous embodiment of the invention,

FIG. 1B illustrates flow chart of an exemplary method for registering a key in a registration server according to an advantageous embodiment of the invention,

FIG. 2 illustrates a block diagram of an exemplary system for a key registration process in a WPKI environment comprising a registration server and a terminal according to an advantageous embodiment of the invention,

FIG. 3 illustrates an exemplary terminal for a key registration process in a WPKI environment according to an advantageous embodiment of the invention,

FIG. 4 illustrates an exemplary SIM/UICC-card for a key registration process in a WPKI environment according to an advantageous embodiment of the invention,

FIG. 5 illustrates a block diagram of an exemplary registration server for registering a key according to an advantageous embodiment of the invention,

FIG. 6A illustrates a block diagram of an exemplary computer program product for forming a registration request in a terminal according to an advantageous embodiment of the invention, and

FIG. 6B illustrates a block diagram of an exemplary computer program product for registering a key in a registration server according to an advantageous embodiment of the invention.

### DETAILED DESCRIPTION

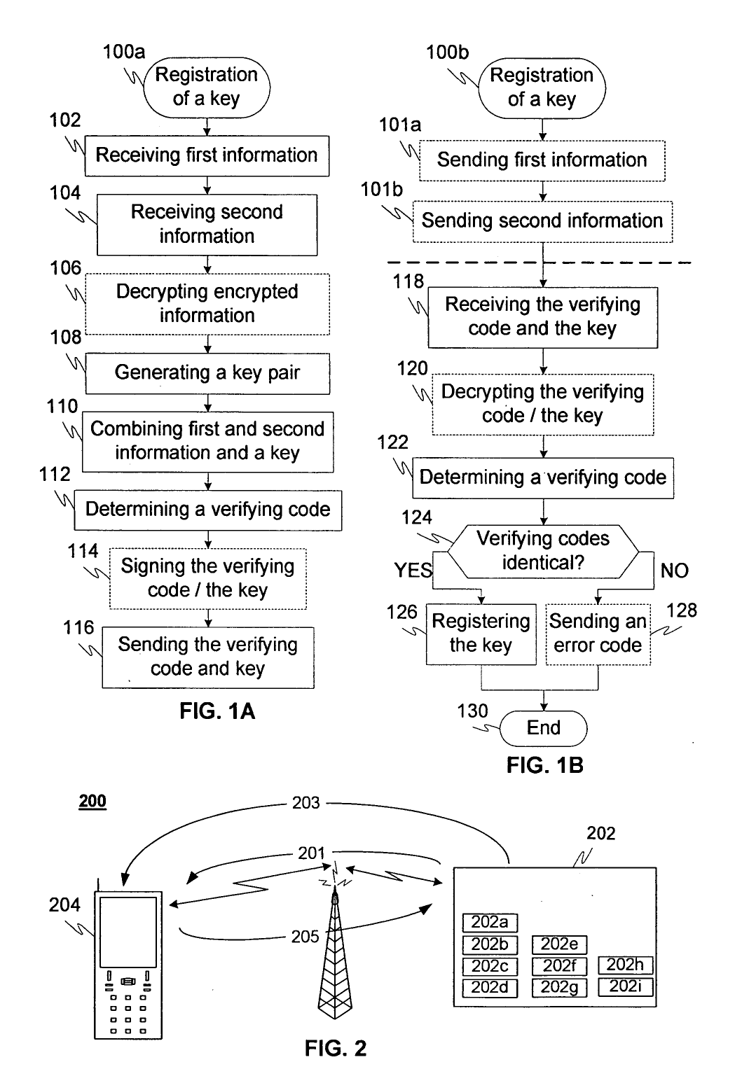

FIG. 1A illustrates a flow chart of an exemplary method 100a for forming a registration request in a terminal (as a client) according to an advantageous embodiment of the invention, where at step 102 first information is received and at step 104 second information is received or alternatively gathered from the environment of the terminal. At step 106 encrypted parts of information are decrypted, if there is any encrypted information. At step 108 a PKI key pair including a private and public keys may be generated, if they are not already pre-generated beforehand either by the terminal or alternatively some other part. Now it should be noted that the order of steps 102-108 described here is only an example and the order may also be different, such as first receiving second information, next generating the key pair and after this receiving first information, for example, whereupon the step 108 could also be optional.

However, after the steps 102-108 said first (A) and second (B) information with the generated public key (PKI) is combined in certain way at step 110. The combination may be for example a string, such as [(A)(B)(PKI)], where (A) is first information, (B) second information and (PKI) the generated public key. The combination may also be any other combination such as a table and it may also comprise only part of information of first information (A), for example.

At step 112 a verifying code, such as a hash code, is determined over the combination of information and the key to be registered, and at step 114 the verifying code can be signed by the generated or pre-generated key, which public key to be registered is delivered to the registration server. However, the step 114 is optional. When the verifying code is determined, it is delivered advantageously with the public key to be registered to a registration server of a certification authority at step 116.

FIG. 1B illustrates flow chart of an exemplary method 100b for registering a key in a registration server according to an advantageous embodiment of the invention, where at step 101a first information and step 101b second information is sent to a terminal. These steps are however optional, because according to an embodiment of the invention also some other party may provide the terminal with said first and/or second information, and according to an embodiment of the invention said second information may also be information gathered by the terminal from it's environment. Moreover the order of the steps 101a, 101b may be different from that described here.

After step 116 depicted in FIG. 1A the verifying code and the key to be registered is received in step 118, after which the possible encryption of the verifying code and/or the key to be registered is decrypted, or the possible signature is verified at step 120. Also the step 120 is optional.

When the registration server has received said verifying code, the registration server determines at step 122 a verifying code also by itself using same first and second information as the terminal did with the public key received from the terminal. At step 124 verifying codes (the first one sent by the terminal and the second one determined by the registration server) are compared. If they are identical, the registration server can be sure that the public key to be registered is indeed from the terminal to which said first and second information were sent, whereupon the public key is registered at step 126 and the process is ended 130. If the verifying codes are not identical, an error code is advantageously sent to the terminal at step 128 (this is however optional) and the process ended 130.

FIG. 2 illustrates a block diagram of an exemplary system 200 according to an advantageous embodiment of the invention for a key registration process in a WPKI environment comprising a registration server 202 being in data communication via a first data communication connection 201 with a terminal 204.

First information usable for forming a registration request is sent from the registration server 202 via said first data communication connection 201 to the terminal 204. Second information (or at least part of it) used for forming the registration request and known also by the registration server 202 is provided to the terminal 204 according to an embodiment of the invention via a second connection 203 separated from the first data communication connection 201. However, a transmission path used for second data can be same as used for first data, but first and second data is not sent during the same connection.

A verifying code determined from said first and second information with a public key to be registered and the public key are delivered to the registration server 202 via a third communication connection 205, which is according to an embodiment of the invention a different connection than the connection 201 used for delivering said first information. However, a transmission path used for delivering the verifying code and the key can be the same as used for the first data.

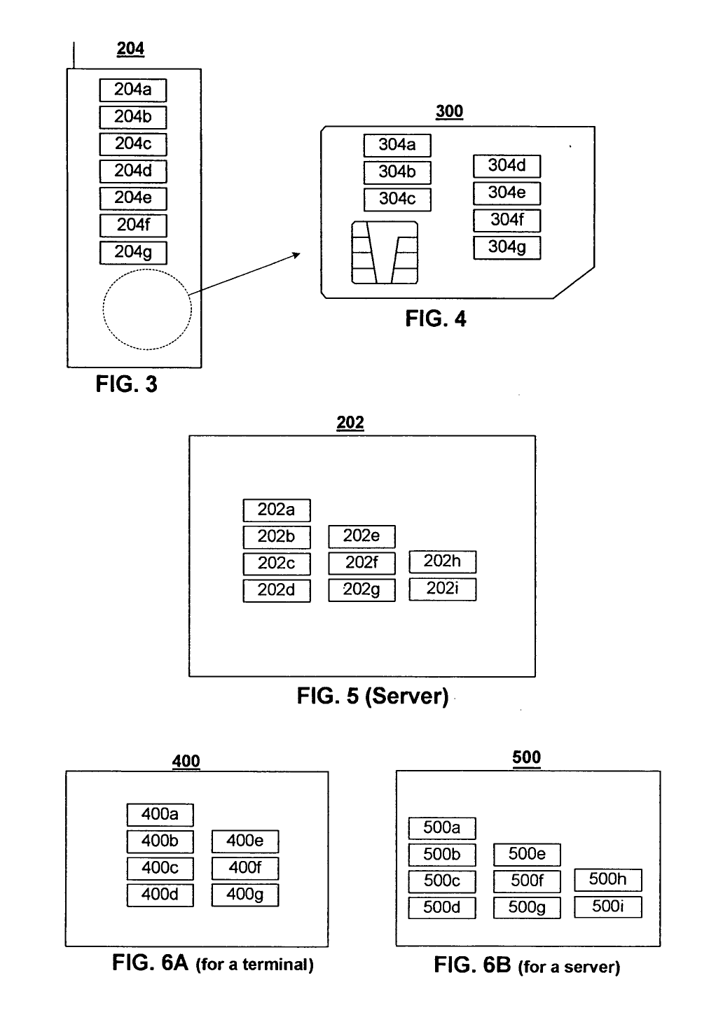

FIG. 3 illustrates an exemplary terminal 204 for a key registration process in a WPKI environment according to an advantageous embodiment of the invention, where the terminal comprises means 204a for receiving first information and means 204b for receiving and/or gathering second information, where means 204b is according to an embodiment of the invention a keyboard, for example, especially when second information must be typed to the terminal. Moreover the terminal 204 comprises means 204c for encrypting, decrypting, signing and/or verifying signature of information, as well as means 204d for generating a PKI key pair including a private and public keys. These means could be a dedicated or general purpose signal processor or some combination of signal processing hardware and software.

In addition the terminal 204 comprises means 204e for combining said first (A) and second (B) information with the generated public key (PKI) in certain way as depicted elsewhere in this document. The terminal comprises also means 204f for determining a verifying code, such as a hash code, of the combination of information and the key to be registered, and means 204g for delivering the verifying code advantageously with the public key to be registered to a registration server of a certification authority. These means also could be any of the above mentioned signal processor/processing devices/software.

FIG. 4 illustrates an exemplary SIM/UICC-card 300 used in a terminal 204 of FIG. 2 for a key registration process in a WPKI environment according to an advantageous embodiment of the invention, where at least part of the functionality of terminal 204 can be performed with the SIM/UICC-card 300. The SIM/UICC-card 300 comprises according to an embodiment of the invention at least one of the following means: means 304a for receiving first information, means 304b for receiving and/or gathering second information for example from the keyboard or other I/O-means, means 304c for encrypting, decrypting signing, and/or verifying a signature of information, as well as means 304d for generating a PKI key pair including a private and public keys, means 304e for combining said first (A) and second (B) information with the generated public key (PKI) in certain way as depicted elsewhere in this document, means 304f for determining a verifying code, and means 304g for outputting the verifying code advantageously with the public key to be delivered to a registration server of a certification authority. Furthermore, these various means may be embodied in signal processing hardware/software as known in the art of signal processing.

FIG. 5 illustrates a block diagram of an exemplary registration server 202 for registering a key according to an advantageous embodiment of the invention, as also shown in FIG. 2, where the registration server 202 comprises means 202a for sending and generating first information and means 202b for sending and generating second information or at least part of it. Moreover the registration server 202 comprises means 202c for receiving a verifying code and the key to be registered, as well as means 202d for decrypting, encrypting, signing and/or verifying a signature of information. These means may also be embodied in signal processing hardware, software, or some combination of hardware and software.

In addition the registration server 202 comprises means 202e for combining said first (A) and second (B) information with the received public key (PKI) in certain way as depicted elsewhere in this document, as well as means 202f for determining a verifying code using first (A) and second (B) information with the received public key (PKI) in similar way as the terminal did. Furthermore the registration server 202 comprises means 202g for comparing the verifying codes (the first one sent by the terminal and the second one determined by the registration server) so that if they are identical, the registration server is adapted to register the public key using means 202h, or otherwise adapted to send an error code using means 202i.

FIG. 6A illustrates a block diagram of an exemplary computer program product 400 such as a computer readable medium for a terminal for forming a registration request in a terminal according to an advantageous embodiment of the invention. The computer program product 400 comprises following means 400a-400g, where means 404a is adapted to receive first information, means 404b adapted to receive and/or gather second information for example from the keyboard or other I/O-means, means 404c adapted to encrypt, decrypt, sign and/or verify a signature of information, as well as means 404d adapted to generate a PKI key pair including a private and public keys, means 404e adapted to combine said first (A) and second (B) information with the generated public key (PKI) in certain way as depicted elsewhere in this document, means 404f adapted to determine a verifying code, and means 404g adapted to output the verifying code advantageously with the public key to be delivered to a registration server of a certification authority, when the computer program product is run on a data processing means, such as a terminal 204 illustrated in FIG. 4, or SIM/UICC-card illustrated in FIG. 4 or other data processing means, such as a laptop computer. In such a case, the various means may comprise various corresponding computer program code modules stored on the computer readable medium.

FIG. 6B illustrates a block diagram of an exemplary computer program product 500 such as a computer readable medium for registering a key in a registration server according to an advantageous embodiment of the invention. The computer program product 500 comprises following means 500a-500i, where means 502a is adapted to send and generate first information, means 502b adapted to send and generate second information or at least part of it, means 502c adapted to receive a verifying code and the key to be registered, as well as means 502d adapted to decrypt, encrypt, sign and/or verify a signature of information, means 502e adapted to combine said first (A) and second (B) information with the received public key (PKI) in certain way as depicted elsewhere in this document, as well as means 502f adapted to determine a verifying code using first (A) and second (B) information with the received public key (PKI) in similar way as the terminal did, means 502g adapted to compare the verifying codes (the first one sent by the terminal and the second one determined by the computer program product itself) so that if they are identical, the computer program product is adapted to register the public key using means 502h, or otherwise adapted to send an error code using means 502i, when said computer program product is run on a data processing means, such as a registration server 202 illustrated in FIG. 5. In such a case also, the various means may comprise various corresponding computer program code modules stored on the computer readable medium.

The invention has now been explained above with reference to the aforementioned embodiments, and several advantages of the invention have been demonstrated. It is clear that the invention is not only restricted to these embodiments, but comprises all possible embodiments within the spirit and scope of the inventive thought and the following patent claims.

Even if the delivery of a public key is described in this document, it should be noted that only information relating to the public key and essential for registering said key in the registration server may be sufficient in certain situations, whereupon the whole key is not necessary to deliver. In addition it should be noted that even if it said in this document that a public key to be registered is delivered to a registration server, it could also be enough in a certain situation to deliver only relevant parts of said public key.

What is claimed is:

1. A method for a secure public key infrastructure (PKI) key registration process in a wireless PKI (WPKI) environment, where the WPKI environment comprises a registration server being in data communication via a first data communication connection with a client provided with a key pair, and where a registration request for a public key of said key pair is provided to said registration server, comprising steps of
a) sending first information usable for forming the registration request from said registration server via said first data communication connection to said client, where at least part of said information is encrypted before sending it from said server to said client,
b) providing said client with second information used for forming the registration request and known by the registration server,
c) decrypting encrypted part of said first information by said client,
d) forming the registration request by combining in a certain way known also by the registration server said second information, at least part of said first information, and a public key of said key pair to be registered to a registration request form, and determining a verifying code using at least part of said request form, and
e) delivering at least said verifying code and public key to be registered to said registration server via a third communication connection, whereupon the registration server also determines a verifying code from the combination of said second information known by said server, used part of said first information and the public key to be registered, and compares the verifying code determined by it to the verifying code received from the client, and registers said public key received from the client if the verifying codes are identical with each other.

2. A method according to claim 1, further comprising the step of providing the client with at least part of said second information via a second connection separated from said first data communication connection.

3. A method according to claim 1, wherein at least part of said second information is information gathered from the environment of the client.

4. A method according to claim 1, further comprising the step of transmitting said second information used for forming the registration request from the client to the registrations server on the third communication connection, if said second information is not known to the registrations server beforehand.

5. A method according to claim 1, wherein the verifying code is a hash code determined using a one-way algorithm.

6. A method according to claim 1, wherein the verifying code is signed before sending it from the client.

7. A method according to claim 1, wherein the client is a SIM-card, UICC-card, tamper resistance means, or a terminal, where the terminal is a mobile phone or portable computer comprising a SIM-card, UICC-card and/or tamper resistance means.

8. A method according to claim 1, wherein the third data communication connection is unsecured connection.

9. A method according to claim 1, further comprising the step of generating the key pair by the client, or pre-generating the key pair outside the client.

10. A method according to claim 1, wherein said first information is a random character string, proof of possession, user-specific information or combination of these, and comprises a greater number of characters as said second information.

11. A method according to claim 1, wherein said second information is proof of possession.

12. A method according to claim 5, wherein said one-way algorithm is a SHA-1, SHA-2, MD5, RIPEMD, RIPEMD-160, RIPEMD-128, RIPEMD-256, RIPEMD-320, Tiger, or WHIRLPOOL algorithm.

13. A method according to claim 1, further comprising the step of signing said verifying code by the private key of the key pair which public key is delivered to the registration server for registering.

14. A method according to claim 1, further comprising the step of triggering a certain time window during which the verifying code and the public key to be registered must be received in the registration server in order to be registered.

15. A system for a secure public key infrastructure (PKI) key registration process in a wireless PKI (WPKI) environment, where the WPKI environment comprises a registration server being in data communication via a first data communication connection with a client provided with a key pair, and where a registration request for a public key of said key pair is provided to said registration server, wherein
the system is adapted to generate and send first information usable for forming the registration request to said client via said first data communication connection, where at least part of said information is encrypted before sending it to said client,
the system is adapted to provide said client with second information used for forming the registration request and known by the registration server,
the system is adapted to decrypt the encrypted part of said first information,
the system is adapted to form the registration request combining in a certain way known also by the registration server said second information, at least part of said first information, and a public key of said key pair to be registered to a registration request form, and further adapted to determine a verifying code using at least part of said request form, and
the system is adapted to deliver at least said verifying code and public key to be registered to said registration server via a third communication connection, whereupon the system is also adapted to determine a verifying code from the combination of said first and second information known by said server and used by the client for determining the verifying code and the public key to be registered, and compare the determined verifying code to the verifying code determined by the client, and register said public key received from the client if the verifying codes are identical with each other.

16. A system according to claim 15, wherein at least part of said second information is provided to the client via a second connection separated from said first data communication connection.

17. A system according to claim 15, wherein at least part of said second information is information gathered from the environment of the client.

18. A system according to claim 15, wherein client is a SIM-card, UICC-card, tamper resistance means, or a terminal, where the terminal is a mobile phone or portable computer comprising a SIM-card, UICC-card, and/or tamper resistance means.

19. A system according to claim 15, wherein the third data communication connection is unsecured connection.

20. A system according to claim 15, wherein the key pair is generated by the client, or the key pair is pre-generated outside the client.

21. A registration server for a secure public key infrastructure (PKI) key registration process in a wireless PKI (WPKI) environment, where the WPKI environment comprises in addition to the registration server a client provided with a key pair and being in data communication via a first data communication connection with the registration server, and where a registration request for a public key of said key pair is provided to said registration server, wherein
the registration server is provided with first and second information usable for forming the registration request by the client,
the registration server is adapted to receive at least a verifying code formed by the client and a public key to be registered via a third communication connection from the client, and
the registration server is also adapted to determine a verifying code from the combination of said first and second information used by the client for determining the verifying code and the public key to be registered, and compare the verifying code determined by it to the verifying code determined by the client, and register said public key received from the client if the verifying codes are identical with each other.

22. A registration server according to claim 21, wherein the registration server is further adapted to
generate and send said first information usable for forming the registration request via said first data communication connection to said client, where at least part of said information is encrypted before sending, and/or
generate and send at least part of said second information used for forming the registration request to said client via a second connection separated from said first data communication connection.

23. A client for a secure public key infrastructure (PKI) key registration process in a wireless PKI (WPKI) environment, where the client is provided with a key pair and the WPKI environment comprises also a registration server being in data communication via a first data communication connection with said client, and where a registration request for a public key of said key pair is provided to said registration server, wherein
client is adapted to receive first information usable for forming the registration request via said first data communication connection, where at least part of said information is encrypted,
client is adapted to use second information for forming the registration request, said second information being also known by the registration server,
client is adapted to decrypt the encrypted part of said first information,
client is adapted to form the registration request combining in a certain way known also by the registration server said second information, at least part of said first information, and a public key of said key pair to be registered to a registration request, and further adapted to determine a verifying code using at least part of said request form, and
client is adapted to deliver at least said verifying code and said public key to said registration server via a third communication connection in order to be registered.

24. A computer program product for a secure public key infrastructure (PKI) key registration process in a wireless PKI (WPKI) environment, where the WPKI environment comprises a registration server being in data communication via a first data communication connection with a client provided with a key pair, and where a registration request for a public key of said key pair is provided to said registration server, wherein said computer program product comprising a computer readable medium configured to
receive first information usable for forming the registration request via said first data communication connection, where at least part of said information is encrypted, and second information usable for forming the registration request, said second information being also known by the registration server
decrypt the encrypted part of said first information,
form the registration request combining in a certain way known also by the registration server said second information, at least part of said first information, and a public key of said key pair to be registered to a registration request form, and further adapted to determine a verifying code using at least part of said request form, and
output the verifying code with the generated public key to be delivered to the registration server
when said computer program product is run by the client.

25. A computer program product for a secure public key infrastructure (PKI) key registration process in a wireless PKI (WPKI) environment, where the WPKI environment comprises a registration server being in data communication via a first data communication connection with a client provided with a key pair, and where a registration request for a public key of said key pair is provided to said registration server, wherein said computer program product comprising a computer readable medium configured to
be provided with first and second information usable for forming the registration request by the client,
receive at least a verifying code formed by the client and a public key to be registered, and
determine a verifying code from the combination of said first and second information used by the client for determining the verifying code and the public key to be registered, and compare the verifying code determined by it to the verifying code determined by the client, and register said public key received from the client if the verifying codes are identical with each other
when said computer program product is run on a computer in the registration server end.
